(19) United States
(12) Patent Application Publication
(10) Pub. No.: US 2025/0085865 A1
(43) Pub. Date: Mar. 13, 2025

(54) SYSTEM INCLUDING PLURALITY OF HOSTS AND PLURALITY OF MEMORY DEVICES AND OPERATION METHOD THEREOF

(71) Applicant: SAMSUNG ELECTRICS CO., LTD, Suwon-si (KR)

(72) Inventor: Sukhyun LIM, Suwon-si (KR)

(73) Assignee: SAMSUNG ELECTRICS CO., LTD., Suwon-si (KR)

(21) Appl. No.: 18/827,316

(22) Filed: Sep. 6, 2024

(30) Foreign Application Priority Data
Sep. 8, 2023 (KR) 10-2023-0119817

(51) Int. Cl. G06F 3/06

(52) U.S. Cl. CPC G06F 3/0619; G06F 3/0659; G06F 3/0688

(57) ABSTRACT

A system includes: a plurality of memory devices, each of the plurality of memory devices including a plurality of memory areas; a host configured to communicate with the plurality of memory devices; and a switch circuit configured to store mapping information for a memory area allocated to the host from among the plurality of memory areas in the plurality of memory devices, wherein a first memory device, from among the plurality of memory devices, is configured to receive at least a portion of the mapping information from the switch circuit, and perform a refresh operation on a plurality of first memory areas in the first memory device, based on at least the portion of the mapping information.

### CROSS-REFERENCE TO RELATED APPLICATION

This application is based on and claims priority under 35 U.S.C. § 119 to Korean Patent Application No. 10-2023-0119817, filed on Sep. 8, 2023 in the Korean Intellectual Property Office, the disclosure of which is incorporated by reference herein in its entirety.

### BACKGROUND

The present disclosure relate to a computing system, and more particularly, to a system including a plurality of hosts and a plurality of memory devices.

An apparatus configured to process data performs various operations by accessing a memory. For example, the apparatus may process data read from the memory, or write the processed data to the memory. Due to performance and functions required by a system, various apparatuses that communicate with each other via a link providing high bandwidth and low latency may be included in the system. The memory included in the system is shared and accessed by two or more apparatuses. Accordingly, the performance of the system depends on not only the operating speed of each apparatus but the communication efficiency between apparatuses and the time required for memory access.

### SUMMARY

One or more example embodiments provide a computing system performing selectively a refresh operation between a plurality of memory devices.

According to an aspect of an example embodiment, a system includes: a plurality of memory devices, each of the plurality of memory devices including a plurality of memory areas; a host configured to communicate with the plurality of memory devices; and a switch circuit configured to store mapping information for a memory area allocated to the host from among the plurality of memory areas in the plurality of memory devices, wherein a first memory device, from among the plurality of memory devices, is configured to receive at least a portion of the mapping information from the switch circuit, and perform a refresh operation on a plurality of first memory areas in the first memory device, based on at least the portion of the mapping information.

According to an aspect of an example embodiment, an operating method of a system, includes: generating allocation information between a plurality of hosts and a plurality of memory devices; providing, to a first memory device from among the plurality of memory devices, partial allocation information related to the first memory device from the allocation information, the first memory device including a plurality of memory areas; performing, based on the partial allocation information, a refresh operation on a memory area allocated to at least one of the plurality of hosts from among the plurality of memory areas in the first memory device; and skipping, based on the partial allocation information, the refresh operation on a memory area not allocated to the plurality of hosts from among the plurality of memory areas in the first memory device.

According to an aspect of an example embodiment, a system includes: a plurality of hosts; a plurality of memory devices configured to communicate with the plurality of hosts, each of the plurality of memory devices including a plurality of memory areas; and a switch circuit configured to store mapping information about a memory area allocated to at least one of the plurality of hosts from among the plurality of memory areas in the plurality of memory devices, wherein a first memory device from among the plurality of memory devices is configured to receive at least a portion of the mapping information from the switch circuit, and perform a refresh operation on a plurality of first memory areas in the first memory device, based on at least the portion of the mapping information.

### BRIEF DESCRIPTION OF THE DRAWINGS

The above and/or other aspects will be more clearly understood from the following detailed description of example embodiments taken in conjunction with the accompanying drawings, in which:

FIG. 1 is a block diagram of a computing system, to which a storage system is applied, according to one or more embodiments;

FIG. 2 is a block diagram of components of a computing system, according to one or more embodiments;

FIG. 3 is a block diagram of a computing system according to one or more embodiments;

FIG. 4 is a diagram for explaining an H2M mapping table according to one or more embodiments;

FIG. 5 is a block diagram of a computing system according to one or more embodiments;

FIG. 6 is a diagram for explaining an H2M mapping table according to one or more embodiments;

FIG. 7 is a diagram of a memory chip according to one or more embodiments;

FIG. 8 is a flowchart of an operating method of a memory device, according to one or more embodiments;

FIG. 9 is a circuit diagram for describing a structure of a refresh manager, according to one or more embodiments;

FIGS. 10A, 10B, and 10C are diagrams for describing a method of skipping a refresh operation by using a write flag, according to embodiments;

FIGS. 11A and 11B are diagrams for describing a write flag per bank, according to embodiments;

FIG. 12 is a block diagram of a computing system according to one or more embodiments;

FIG. 13 is a block diagram of a computing system according to one or more embodiments; and

FIG. 14 is a block diagram of a computing system according to one or more embodiments.

### DETAILED DESCRIPTION

Hereinafter, various embodiments of the present disclosure are described in conjunction with the accompanying drawings.

It will be understood that, although the terms first, second, third, fourth, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

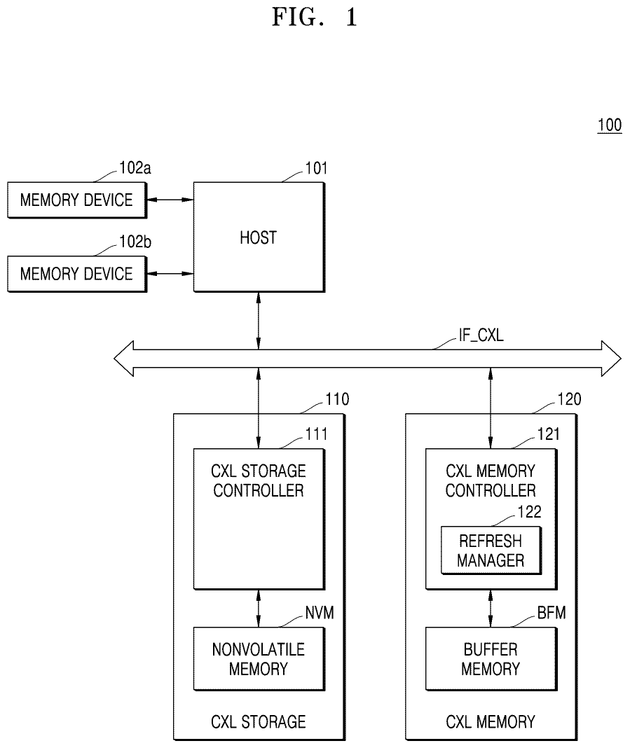

FIG. 1 is a block diagram of a computing system 100, to which a storage system is applied, according to one or more embodiments.

Referring to FIG. 1, the computing system 100 may include a host 101, a plurality of memory devices 102a and 102b, a storage 101 and a memory 120. In one or more examples, the storage 110 may be a computer express link (CXL) storage, and the memory 120 may be a CXL memory. In one or more examples, a CXL is a high-speed interconnect, industry-standard interface for communications between processors, accelerators, memory, storage, and other IO devices. CXL increases efficiency by allowing composability, scalability, and flexibility for heterogeneous and distributed compute architectures.

In one or more embodiments, the computing system 100 may be included in a user device, such as a laptop computer, a server, a media player, and a digital camera, or an automotive device, such as a navigation device, a black box, and an automotive electrical device. In one or more examples, the computing system 100 may include a mobile phone, a smart phone, a tablet personal computer, a wearable device, a health care device, or a mobile system such as an Internet of Things (IoT) device.

The host 101 may control the overall operation of the computing system 100. In one or more embodiments, the host 101 may include one of various processors, such as a central processing unit (CPU), a graphics processing unit (GPU), a neural processing unit (NPU), and a data processing unit (DPU). In one or more embodiments, the host 101 may include a single core processor or a multi core processor.

The plurality of memory devices 102a and 102b may be used as a main memory or a system memory of the computing system 100. In one or more embodiments, each of the plurality of memory devices 102a and 102b may include a dynamic random access memory (RAM) (DRAM) device, and may have a form factor of a dual in-line memory module (DIMM). However, the scope of the embodiments of the present disclosure is not limited thereto, and the plurality of memory devices 102a and 102b may include non-volatile memories, such as flash memory, phase change RAM (PRAM), resistive RAM (RRAM), and magnetic RAM (MRAM).

The plurality of memory devices 102a and 102b may directly communicate with the host 101 via a double data rate (DDR) interface. In one or more embodiments, the host 101 may include a memory controller configured to control the plurality of memory devices 102a and 102b. However, the scope of the embodiments of the present disclosure is not limited thereto, and the plurality of memory devices 102a and 102b may communicate with the host 101 via various interfaces.

The CXL storage 110 may include a CXL storage controller 111 and a non-volatile memory NVM. The CXL storage controller 111 may, according to the control of the host 101, store data in the non-volatile memory NVM or transmit data stored in the non-volatile memory NVM to the host 101. In one or more embodiments, the non-volatile memory NVM may include a NAND flash memory. However, the scope of the embodiments of the present disclosure is not limited thereto.

The CXL memory 120 may include a CXL memory controller 121 and a buffer memory BFM. The CXL memory controller 121 may, according to the control of the host 101, store data in the buffer memory BFM, or transmit data stored in the buffer memory BFM to the host 101. In one or more embodiments, the buffer memory BFM may include DRAM, but the scope of the embodiments of the present disclosure is not limited thereto.

In one or more embodiments, the host 101, the CXL storage 110, and the CXL memory 120 may be configured to share the same interfaces. For example, the host 101, the CXL storage 110, and the CXL memory 120 may communicate with each other via a CXL interface IF_CXL. In one or more embodiments, the CXL interface IF_CXL may support coherency, memory access, and dynamic protocol multiplexing of input/output (I/O) protocol, and may refer to a low-latency and high bandwidth link enabling various connections between accelerators, memory devices, or various electronic devices.

In one or more embodiments, the CXL storage controller 111 may manage data stored in the non-volatile memory NVM by using map data. The map data may include information about a relation between a logical block address managed by the host 101 and a physical block address of the non-volatile memory NVM.

In one or more embodiments, the CXL storage 110 may not include a separate buffer memory for storing or managing the map data. In this case, a buffer memory for storing or managing the map data may be needed. In one or more embodiments, at least a partial area of the CXL memory 120 may be used as a buffer memory of the CXL storage 110. In this case, a mapping table managed by the CXL storage controller 111 of the CXL storage 110 may be stored in the CXL memory 120. For example, at least a partial area of the CXL memory 120 may be allocated as a buffer memory of the CXL storage 110 (e.g., a dedicated area for the CXL storage 110) by the host 101. In one or more examples, the partial area of the CXL memory 120 may be contiguous or non-contiguous. For example, the CXL memory 120 may be segmented into a plurality of pages, where the allocated partial area may be composed of a contiguous set of pages, or a set of pages in which at least one page is non-contiguous with the other pages in the set of pages.

In one or more embodiments, the CXL storage 110 may access the CXL memory 120 via the CXL interface IF_CXL. For example, the CXL storage 110 may store a mapping table in an allocated area among areas of the CXL memory 120 or read the stored mapping table. The CXL memory 120 may, according to the control of the CXL storage 110, store data (e.g., the map data) in the buffer memory BFM or transmit the data stored in the buffer memory BFM (e.g., the map data) to the CXL storage 110.

The CXL storage controller 111 of the CXL storage 110 may communicate with the host 101 and the CXL memory 120 (e.g., the buffer memory) via the CXL interface IF_CXL. In one or more examples, the CXL storage controller 111 of the CXL storage 110 may communicate with the host 101 and the CXL memory 120 via a homogeneous interface or a common interface, and may use a partial area of the CXL memory 120 as a buffer memory.

Hereinafter, for convenience of description, it is assumed that the host 101, the CXL storage 110, and the CXL memory 120 communicate with each other via the CXL interface IF_CXL. However, the scope of the embodiments of the present disclosure is not limited thereto, and the host 101, the CXL storage 110, and the CXL memory 120 may communicate with each other based on various computing interfaces, such as GEN-Z protocol, NVLink protocol, cache coherent interconnect for accelerators (CCIX) protocol, open coherent accelerator processor interface (CAPI) protocol, or any other suitable interface known to one of ordinary skill in the art.

In one or more embodiments of the embodiments of the present disclosure, the CXL memory controller 121 may include a refresh manager 122. The refresh manager 122 may manage a refresh operation on a plurality of memories included in the buffer memory BFM. Some of the plurality of memories included in the buffer memory BFM may be allocated to the host 101, and the remaining of the plurality of memories may not be allocated to the host 101. The refresh manager 122 may control the buffer memory BFM so that the refresh operation is performed on memories allocated to the host 101. Furthermore, the refresh manager 122 may control the buffer memory BFM so that the refresh operation is not performed on memories not allocated to the host 101. The refresh manager 122 may be implemented as hardware or software, but one or more embodiments is not limited thereto.

According to one or more embodiments of the embodiments of the present disclosure, because the refresh operation is performed only on memories allocated to the host 101, power consumed for maintaining data stored in memories included in the buffer memory BFM may be reduced.

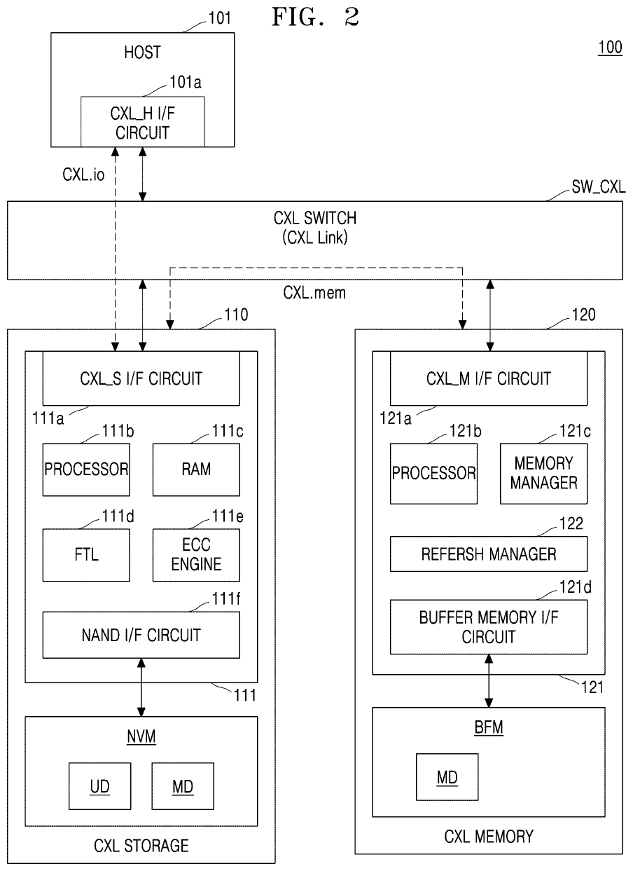

FIG. 2 is a block diagram of components of the computing system 100, according to one or more embodiments. FIG. 2 is a detailed block diagram of components of the computing system 100 of FIG. 1. FIG. 2 may be described with reference to FIG. 1, and duplicate descriptions thereof are omitted.

Referring to FIG. 2, the computing system 100 may include a CXL switch SW_CXL, the host 101, the CXL storage 110, and the CXL memory 120.

The CXL switch SW_CXL may include a component included in the CXL interface IF_CXL. The CXL switch SW_CXL may be configured to mediate communication between the host 101, the CXL storage 110, and the CXL memory 120. For example, when the host 101 communicates with the CXL storage 110, the CXL switch SW_CXL may be configured to transmit information, such as a request, data, a reply, and a signal, transmitted by the host 101 or the CXL storage 110 to the CXL storage 110 or the host 101. When the host 101 communicates with the CXL memory 120, the CXL switch SW_CXL may be configured to transmit information, such as a request, data, a reply, and a signal, transmitted by the host 101 or the CXL memory 120 to the CXL storage 110 or the host 101. When the CXL storage 110 communicates with the CXL memory 120, the CXL switch SW_CXL may be configured to transmit information, such as a request, data, a reply, and a signal, transmitted by the CXL storage 110 or the CXL memory 120 to the CXL memory 120 or the CXL storage 110. The host 101 may include a CXL host interface (CXL_H I/F) circuit 101a. The CXL_H I/F circuit 101a may communicate with the CXL storage 110 or the CXL memory 120 via the CXL switch SW_CXL.

According to one or more embodiments, the CXL storage 110 may include a CXL storage controller 111 and the non-volatile memory NVM. The CXL storage controller 111 may include a CXL storage interface (CXL_S I/F) circuit 111a, a processor 111b, RAM 111c, a flash translation layer (FTL) 111d, an error correction code (ECC) engine 111e, and a NAND I/F circuit 111f.

The CXL_S I/F circuit 111a may be connected to the CXL switch SW_CXL. The CXL_S I/F circuit 111a may communicate with the host 101 or the CXL memory 120 via the CXL switch SW_CXL.

The processor 111b may be configured to control the overall operation of the CXL storage controller 111. The RAM 111c may be used as an operation memory or a buffer memory of the CXL storage controller 111.

The FTL 111d may perform various management operations for efficient use of the non-volatile memory NVM. For example, based on the map data (or the mapping table), the FTL 111d may perform an address conversion between the logical block address managed by the host 101 and the physical block address used by the non-volatile memory NVM. The FTL 111d may perform a bad block management operation on the non-volatile memory NVM. The FTL 111d may perform a wear leveling operation on the non-volatile memory NVM. The FTL 111d may perform a garbage collection operation on the non-volatile memory NVM. In one or more examples, bad block management may include detecting and marking bad blocks, utilizing the reserved extra capacity to substitute the unusable blocks, and preventing data from being written to bad blocks, thereby increasing reliability of the memory. In one or more examples, a wear leveling operation may be a process for extending the life of memory devices (e.g., NAND flash memory) to ensure that all of the memory blocks reach their maximum endurance limit specified by a manufacturer. For example, the wear leveling operation may even out a distribution of program/erase operations on all available blocks by writing all new or updated data to a free block, and then erasing the block containing old data and making the erased block available in the free block pool.

In one or more embodiments, the FTL 111d may be implemented as software, hardware, firmware, or a combination thereof. When the FTL 111d is implemented as software or firmware, program code related to the FTL 111d may be stored in the RAM 111c, and may be driven by the processor 111b. When the FTL 111d is implemented as hardware, hardware components configured to perform various management operations described above may be implemented in the CXL storage controller 111.

The ECC engine 111e may perform error detection and correction operations on data stored in the non-volatile memory NVM. For example, the ECC engine 111e may generate a parity bit for user data UD to be stored in the non-volatile memory NVM, and the generated parity bit may be stored in the non-volatile memory NVM with the user data UD together. When the user data UD is read from the non-volatile memory NVM, the ECC engine 111e may use the parity bits read from the non-volatile memory NVM together with the read user data UD to detect errors in the user data UD and correct the errors.

The NAND I/F circuit 111f may control the non-volatile memory NVM so that data is stored in the non-volatile memory NVM or data is read from the non-volatile memory NVM. In one or more embodiments, the NAND I/F circuit 111f may be implemented to observe standard conventions, such as a toggle interface and an open NAND flash interface (ONFI). For example, the non-volatile memory NVM may include a plurality of NAND flash memories, and when the NAND I/F circuit 111f is implemented based on a toggle interface, the NAND I/F circuit 111f may communicate with a plurality of NAND flash devices via a plurality of channels. The plurality of NAND flash devices may be connected to the plurality of channels via a multichannel-multiway structure.

The non-volatile memory NVM may store or output the user data UD according to the control of the CXL storage controller 111. The non-volatile memory NVM may store or output map data MD according to the control of the CXL storage controller 111. In one or more embodiments, the map data MD stored in the non-volatile memory NVM may include mapping information corresponding to all user data UD stored in the non-volatile memory NVM. The map data MD stored in the non-volatile memory NVM may be stored in the CXL memory 120 at an initialization operation of the CXL storage 110.

The CXL memory 120 may include the CXL memory controller 121 and the buffer memory BFM. The CXL memory controller 121 may include a CXL memory interface CXL_M I/F circuit 121a, a processor 121b, a memory manager 121c, and a buffer memory I/F circuit 121d.

The CXL_M I/F circuit 121a may be connected to the CXL switch SW_CXL. The CXL_M I/F circuit 121a may communicate with the host 101 or the CXL storage 110 via the CXL switch SW_CXL.

The processor 121b may be configured to control the overall operation of the CXL memory controller 121. The memory manager 121c may be configured to manage the buffer memory BFM. For example, the memory manager 121c may be configured to convert a memory address (e.g., a logical address or a virtual address) accessed from the host 101 or the CXL storage 110 into a physical address for the buffer memory BFM. In one or more embodiments, the memory address may be an address for managing a storage area of the CXL memory 120, and may be a logical address or a virtual address designated and managed by the host 101.

A buffer memory I/F circuit 121d may control the buffer memory BFM so that data is stored in the buffer memory BFM or data is read from the buffer memory BFM. In one or more embodiments, the buffer memory I/F circuit 121d may be implemented to comply to standard conventions, such as the DDR interface and the low power DDR (LPDDR) interface.

The buffer memory BFM may store data or output the stored data according to the control of the CXL memory controller 121. In one or more embodiments, the buffer memory BFM may be configured to store the map data MD used by the CXL storage 110. The map data MD may be transferred from the CXL storage 110 to the CXL memory 120, in the initialization operation of the computing system 100 or in the initialization operation of the CXL storage 110.

As described above, the CXL storage 110 according to one or more embodiments may store, in the CXL memory 120 connected thereto, the map data MD required for managing the non-volatile memory NVM via the CXL switch SW_CXL, or the CXL interface IF_CXL. Thereafter, when the CXL storage 110 performs a read operation according to a request of the host 101, the CXL storage 110 may read at least a portion of the map data MD from the CXL memory 120 via the CXL switch SW_CXL, or the CXL interface IF_CXL, and perform a read operation based on the read map data MD. In one or more examples, when the CXL storage 110 performs a write operation according to a request of the host 101, the CXL storage 110 may perform a write operation in the non-volatile memory NVM, and update the map data MD. In this case, the updated map data MD may be firstly stored in the RAM 111c of the CXL storage controller 111, and the map data MD stored in the RAM 111c may be transferred to the buffer memory BFM of the CXL memory 120 via the CXL switch SW_CXL, or the CXL interface IF_CXL), and may be updated.

In one or more embodiments, a portion of the area of the buffer memory BFM of the CXL memory 120 may be allocated as a dedicated area for the CXL storage 110, and the remaining unallocated area may be used as an area accessible by the host 101.

In one or more embodiments, the host 101 and the CXL storage 110 may communicate with each other by using an input/output (I/O) protocol CXL.io. The I/O protocol CXL.io may have an inconsistency I/O protocol based on peripheral component interconnect express (PCIe). The host 101 and the CXL storage 110 may transceive user data or various information with each other by using the I/O protocol CXL.io.

In one or more embodiments, the CXL storage 110 and the CXL memory 120 may communicate with each other by using a memory access protocol CXL.mem. The memory access protocol CXL.mem may include a memory access protocol supporting a memory access. By using the memory access protocol CXL.mem, the CXL storage 110 may access a partial area of the CXL memory 120 (e.g., an area where the map data MD is stored, or a CXL storage dedicated area).

In one or more embodiments, the host 101 and the CXL memory 120 may communicate with each other by using the memory access protocol CXL.mem. By using the memory access protocol CXL.mem, the host 101 may access a remaining area of the CXL memory 120 (e.g.,, the remaining area except for the area where the map data MD is stored, or the remaining area except for the CXL storage dedicated area).

The access types described above (CXL.io, CXL.mem, or any other suitable access type) are merely examples, and the scope of the embodiments of the present disclosure is not limited thereto.

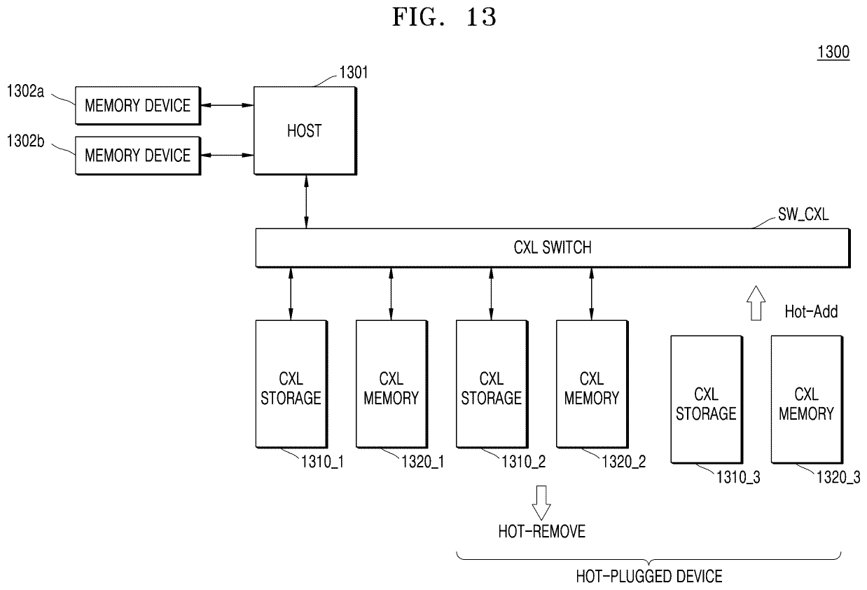

In one or more embodiments, the CXL storage 110 and the CXL memory 120 may be mounted on a physical port (e.g., a PCIe physical port) based on the CXL interface. In one or more embodiments, the CXL storage 110 and the CXL memory 120 may be implemented based on form factors, such as E1.S, E1.L, E3.S, E3.L, and PCIe AIC (CEM). In one or more examples, the CXL storage 110 and the CXL memory 120 may be implemented based on a U.2 form factor, an M.2 form factor, or a form factor based on other various types of PCI2, or a small form factor of other various types. The CXL storage 110 and the CXL memory 120 may support a hot-plug mountable on or removable from the physical port. Detailed descriptions of hot-plug functions are given below with reference to FIG. 13.

According to one or more embodiments of the embodiments of the present disclosure, the CXL memory controller 121 may include a refresh manager 122. The refresh manager 122 may control a refresh operation of the buffer memory BFM. The refresh manager 122 may control the buffer memory BFM so that the refresh operation is performed on memories allocated to the host 101 among the plurality of memories included in the buffer memory BFM, and the refresh operation is not performed on the remaining memories (e.g., unallocated memories).

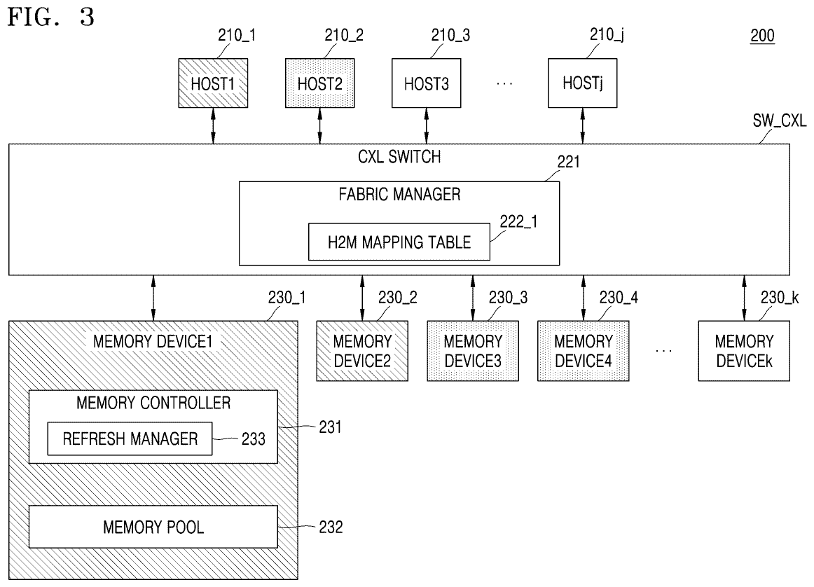

FIG. 3 is a block diagram of a computing system 200 according to one or more embodiments.

In the embodiments of the present disclosure, the computing system 200 may be referred to as a system. Referring to FIG. 3, the computing system 200 may correspond to the computing system 100 of FIG. 2. The computing system 200 of FIG. 3 may include first host (host1) 210_1 through j^{th} host (hostj) 210_j (e.g., j is an integer of 2 or more), the CXL switch SW_CXL, and first memory device (memory device1) 230_1 through k^{th} memory device (memory devicek) 230_1 to 230_k (e.g., k is an integer of 2 or more). In this case, the number of the host1 210_1 through hostj 210_j may be different from the number of the memory device1 230_1 through memory devicek 230_k. Each of the memory device1 230_1 through k^{th} memory devicek 230_k illustrated in FIG. 3 may correspond to the CXL memory 120 or peripheral devices which communicate via the CXL interface IF_CXL and perform the refresh operation.

The host1 210_1 through jth hostj 210_j may be configured to communicate with the first memory device1 230_1 through kth memory devicek 230_k via the CXL switch SW_CXL. A host which requires memory allocation may transmit a memory allocation request to the CXL switch SW_CXL.

The CXL switch SW_CXL in FIG. 3 may correspond to the CXL switch SW_CXL in FIG. 1. In the embodiments of the present disclosure, the CXL switch SW_CXL may be referred to as a switch or a switch circuit. The CXL switch SW_CXL may be configured to provide connections between the host1 210_1 through hostj 210_j and the memory device1 230_1 through memory devicek 230_k.

The CXL switch SW_CXL may include a fabric manager 221. The fabric manager 221 may allocate the memory device1 230_1 through the memory devicek 230_k to the host1 210_1 through hostj 210_j, in response to the memory allocation request received from the host1 through hostj 210_j. For example, the fabric manager 221 may allocate a memory device to a host based on category information of an application executed by the host, performance information required by the host, etc.

When the memory device1 230_1 through memory devicek 230_k are connected to the CXL switch SW_CXL, the fabric manager 221 may allocate the memory device1 230_1 through memory devicek 230_k to the host1 210_1 through the hostj 210_j, based on device information received from the memory device1 230_1 through memory devicek 230_k. In one or more embodiments, the device information may be referred to as device status information, status information, or health information.

The fabric manager 221 may manage mapping between a host and a memory device based on a host-memory mapping table 222_1. The fabric manager 221 may be implemented as software, hardware, firmware, or a combination thereof.

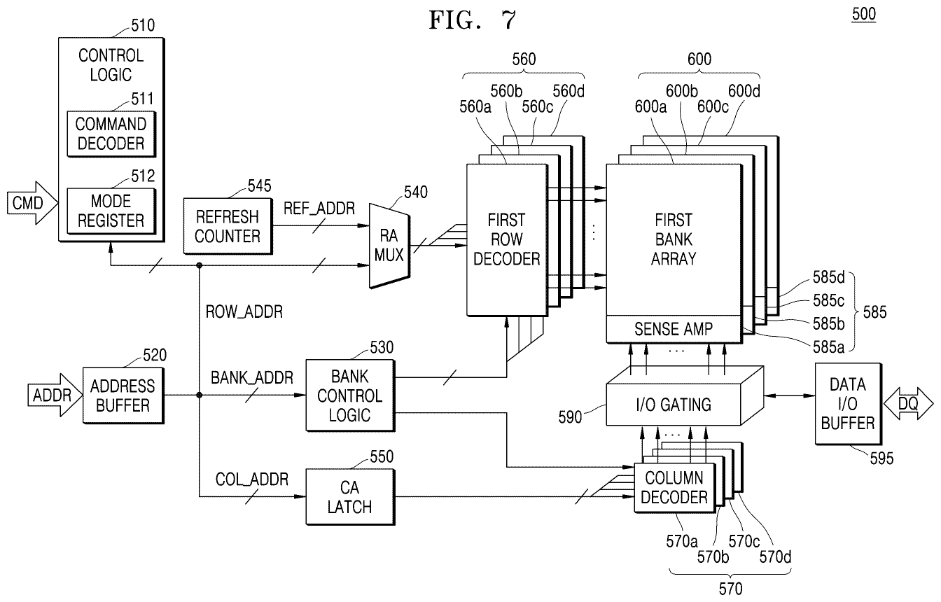

The memory device1 230_1 may include a memory controller 231 and a memory pool 232, and the memory pool 232 may correspond to the buffer memory BFM. The memory pool 232 may include a plurality of memory blocks. The memory block may be a unit logically dividing the memory pool 232. For example, the memory block may correspond to a memory chip 500 in FIG. 7 and one of first through fourth bank arrays 700a through 700d.

In the embodiments of the present disclosure, that the memory device is allocated to a host may mean that at least one memory block included in a memory pool of a memory device is allocated to a host.

In FIG. 3, the memory device1 230_1 and memory device2 230_2 may be allocated to the host1 210_1, and the memory device3 230_3 and memory device4 230_4 may be allocated to the host2 210_2. The hosts host3 210_3 through hostj 230_j may not be allocated to the memory device1 230_1 through memory devicek 230_k. The memory devicek 230_k may not be allocated to the first host 210_1 through jth host 210_j. As understood by one of ordinary skill in the art, these allocations are merely examples.

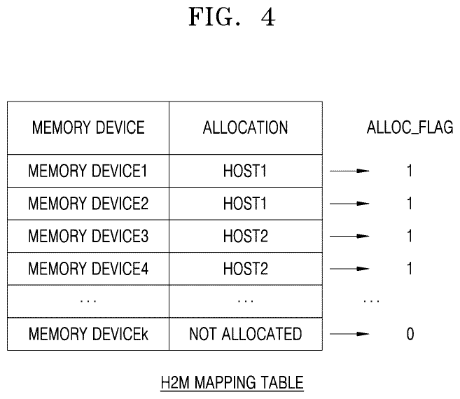

FIG. 4 is a diagram for explaining an H2M mapping table according to one or more embodiments. FIG. 4 may be described with reference to FIG. 3.

Referring to FIG. 4, the H2M mapping table may include information for hosts to which memory devices are allocated. For example, the memory device1 230_1 and memory device2 230_2 may be allocated to the host1 210_1, and the memory device3 230_3 and memory device4 230_4 may be allocated to the host2 210_2. As described with reference to FIG. 3, the memory devicek 230_k may not be allocated to any other host.

In some embodiments, the H2M mapping table may include information about allocation flags. The allocation flag may indicate whether a memory device is allocated to a host. For example, when a memory device is allocated to a host, the allocation flag of the corresponding memory device may be ‘1’, but when a memory device is not allocated to a host, the allocation flag of the corresponding memory device may be ‘0’.

However, one or more embodiments is not limited thereto, and the H2M mapping table may also not include an allocation flag.

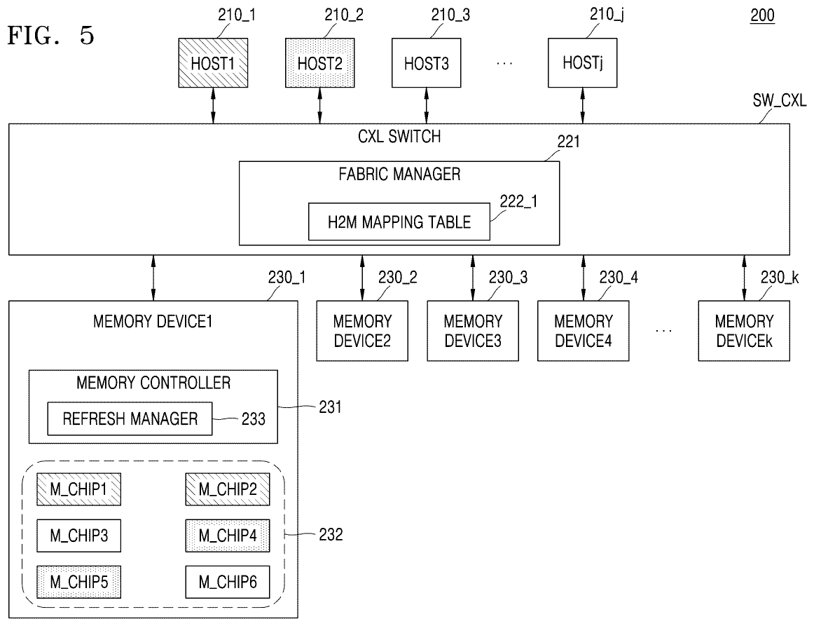

FIG. 5 is a block diagram of a computing system 200 according to one or more embodiments. Descriptions of the memory device1 230_1 may also be applied to the memory device2 through memory devicek 230_2 through 230_k.

Referring to FIG. 5, the memory pool 232 may include first through sixth memory chips M_CHIP1 through M_CHIP6. The number of memory chips included in the memory pool 232 is not limited thereto. The first and second memory chips M_CHIP1 and M_CHIP2 may be allocated to the host1 210_1. The fourth and fifth memory chips M_CHIP4 and M_CHIP5 may be allocated to the host2 210_2. The third and sixth memory chips M_CHIP3 and M_CHIP6 may be in a state of not being allocated to any host.

A refresh manager 233 may generate an internal refresh command so that the refresh operation is performed on the first, second, fourth, and fifth memory chips M-CHIP1, M_CHIP2, M_CHIP4, and M_CHIP5, and the refresh operation is not performed on the third and sixth memory chips M_CHIP3 and M_CHIP6.

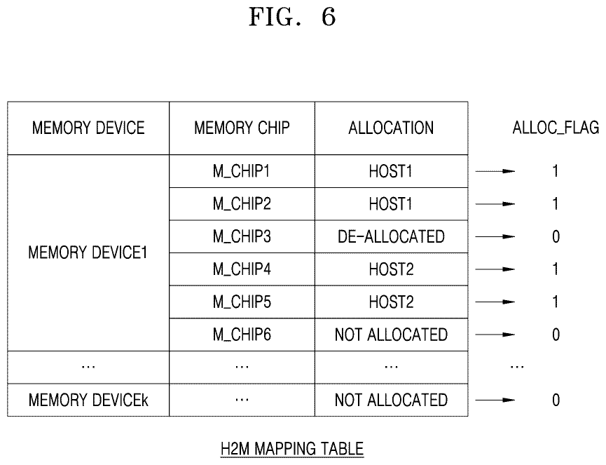

FIG. 6 is a diagram for explaining the H2M mapping table according to one or more embodiments. FIG. 6 is described with reference to FIG. 5.

Referring to FIG. 6, the H2M mapping table may include information for hosts to which a plurality of memory devices are allocated. For example, the first and second memory chips M_CHIP1 and M_CHIP2 may be allocated to the host1 210_1, and the fourth and fifth memory chips M_CHIP4 and M_CHIP5 may be allocated to the host2 210_2. As described above with reference to FIG. 5, the third and sixth memory chips M_CHIP3 and M_CHIP6 may not be allocated to any host. The third memory chip M_CHIP3 may be in a state of being allocation-released, and the sixth memory chip M_CHIP6 may be in a state of not being-allocated history.

In some embodiments, the H2M mapping table may include information about the allocation flags. The allocation flag may indicate whether a host is allocated to a memory chip. For example, when a memory chip is allocated to a host, the allocation flag of the corresponding memory chip may be ‘1’, but when a memory chip is not allocated to a host, the allocation flag of the corresponding memory chip may be ‘0’.

However, one or more embodiments is not limited thereto, and the H2M mapping table may also not include an allocation flag.

FIG. 7 is a diagram of the memory chip 500 according to one or more embodiments.

Referring to FIG. 7, the memory chip 500 may include a control logic circuit 510, an address buffer 520, a bank control logic circuit 530, a row address (RA) multiplexer (MUX) (RA MUX) 540, a column address (CA) latch (CA latch) 550, a row decoder 560, a column decoder 570, a memory cell array 600, a sense amplifier (AMP) 585, an input/output (I/O) gating circuit 590, a data I/O buffer 595, and a refresh counter 545. In the embodiments of the present disclosure, a memory block or a memory chip may be referred to as a memory area.

The memory cell array 600 may include first through fourth bank arrays 600a through 600d. In one or more examples, the row decoder 560 may include first through fourth bank row decoders 560a through 560d respectively connected to the first through fourth bank arrays 600a through 600d, the column decoder 570 may include first through fourth bank column decoders 570a through 570d respectively connected to the first through fourth bank arrays 600a through 600d, and the sense AMP 585 may include first through fourth bank sense AMPs 585a through 585d respectively connected to the first through fourth bank arrays 600a through 600d.

The first through fourth bank arrays 600a through 600d, the first through fourth bank sense AMPs 585a through 585d, the first through fourth bank column decoders 570a through 570d, and the first through fourth bank row decoders 560a through 560d may each constitute first through fourth banks. Each of the first through fourth bank arrays 600a through 600d may include a plurality of word lines and a plurality of bit lines, and a plurality of memory cells formed at points where the word lines intersect with the bit lines.

An example of the memory chip 500 including four banks is illustrated in FIG. 7, but according to one or more embodiments, the memory chip 500 may include an arbitrary number of banks.

The address buffer 520 may receive an address ADDR including a bank address BANK_ADDR, a row address ROW_ADDR, and a column address COL_ADDR from the memory controller 231. The address buffer 520 may provide the received bank address BANK_ADDR to a bank control logic circuit 530, the received row address ROW_ADDR to the RA MUX 540, and the received column address COL_ADDR to the CA latch 550.

The bank control logic circuit 530 may generate bank control signals in response to the bank address BANK_ADDR. In response to the bank control signals, a bank row decoder corresponding to the bank address BANK_ADDR among the first through fourth bank row decoders 560a through 560d may be activated, and a bank column decoder corresponding to the bank address BANK_ADDR among the first through fourth bank column decoders 570a through 570d may be activated.

The RA MUX 540 may receive the row address ROW_ADDR from the address buffer 520, and may receive a refresh row address REF_ADDR from the refresh counter 545. The RA MUX 540 may selectively output the row address ROW_ADDR or the refresh row address REF_ADDR as a row address RA. The row address RA output by the RA MUX 540 may be applied to each of the first through fourth bank row decoders 560a through 560d. The bank row decoder activated by the bank control logic circuit 530 among the

first through fourth bank row decoders 560a through 560d may decode the row address RA output by the RA MUX 540 and activate a word line corresponding to the row address RA. For example, the activated bank row decoder may apply a word line driving voltage to the word line corresponding to the row address RA. The activated bank row decoder may generate the word line driving voltage by using the power voltage VDD, and may provide the word line driving voltage to the corresponding word line.

The CA latch 550 may receive the column address COL_ADDR from the address buffer 520, and may temporarily store the received column address COL_ADDR or a mapped column address MCA. In one or more examples, the CA latch 550 may, in a burst mode, gradually increase the received column address COL_ADDR. The CA latch 550 may apply the column address COL_ADDR, which may be temporarily stored or gradually increased, to each of the first through fourth bank column decoders 570a through 570d.

The bank column decoder activated by the bank control logic circuit 530 among the first through fourth bank column decoders 570a through 570d may activate a sense AMP corresponding to the bank address BANK_ADDR and the column address COL_ADDR via the I/O gating circuit 590.

The I/O gating circuit 590 may include, with circuits gating I/O data together, read data latches for storing data output by the first through fourth bank arrays 600a through 600d, and write drivers for writing data in the first through fourth bank arrays 600a through 600d.

Data read from one bank array among the first through fourth bank arrays 600a through 600d may be sensed by a sense amp corresponding to the one bank array, and stored in the read data latches.

Data stored in the read data latches may be provided to the memory controller 231 via the data I/O buffer 595. Data to be written in one bank array among the first through fourth bank arrays 600a through 600d may be provided from the memory controller 231 to the data I/O buffer 595. Data provided to the data I/O buffer 595 may be provided to the I/O gating circuit 590.

The control logic circuit 510 may control an operation of the memory chip 500. For example, the control logic circuit 510 may generate control signals so that the memory chip 500 performs a write operation or a read operation. The control logic circuit 510 may include a command decoder 511 for decoding a command CMD received by the memory controller 231, and a mode register 512 for setting an operation mode of the memory chip 500.

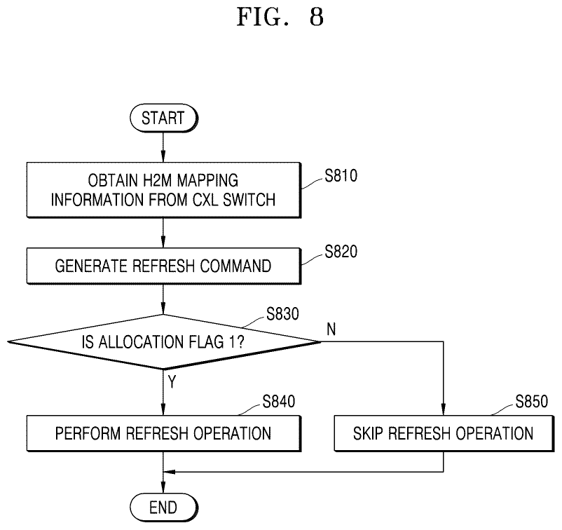

When the refresh command (e.g., a first internal refresh command in FIG. 8) is received from the memory controller 231, the memory chip 500 may perform the refresh operation on a bank array corresponding to a refresh address REF_ADDR. The refresh operation may include an auto refresh operation and a self-refresh operation. The auto refresh operation may generate the refresh address REF_ADDR in response to a refresh command applied periodically, and may refresh a memory cell row corresponding to the refresh address REF_ADDR. The self-refresh operation may correspond an operation of entering a self-refresh mode in response to a self-refresh enter command, and refresh memory cell rows by using a built-in timer in the self-refresh mode.

FIG. 8 is a flowchart of an operating method of a memory device, according to one or more embodiments. FIG. 8 is described with reference to FIG. 5.

The memory controller 231 included in the memory device1 230_1 may obtain a portion of H2M mapping information from the CXL switch SW_CXL (S810). For example, the memory controller 231 may obtain information about hosts, to which the memory device1 230_1 has been allocated, from the H2M mapping table of FIG. 6. According to the H2M mapping information obtained by the memory device1 230_1, the first and second memory chips M_CHIP1 and M_CHIP2 may be allocated to the host1 210_1, the fourth and fifth memory chips M_CHIP4 and M_CHIP5 may be allocated to the host2 210_2, and the third and sixth memory chips M_CHIP3 and M_CHIP6 may be in a state of not being allocated to any host. The memory controller 231 may obtain the allocation flag. In some embodiments, the memory controller 231 may receive information about the allocation flag from the CXL switch SW_CXL. In some embodiments, the memory controller 231 may generate the allocation flag based on the mapping information between a memory chip and a host.

The memory controller 231 may generate the refresh command for requesting the refresh operation on at least one of the first through sixth memory chips M_CHIP1 through M_CHIP6 included in the memory device1 230_1 (S820). The refresh command may be generated at a preset time interval.

When the allocation flag corresponding to a memory chip is ‘1’, the memory device1 230_1 may perform the refresh operation on the corresponding memory chip (S840). The memory controller 231 may provide the refresh command to the memory chip, in which the allocation flag is ‘1’ (e.g., S830=Y), and the memory chip having received the refresh command may perform the refresh operation.

When the allocation flag corresponding to the memory chip is ‘0’ (e.g., S830=N), the memory device1 230_1 may skip the refresh operation on the corresponding memory chip (S850). The memory controller 231 may not provide the refresh command to a memory chip in which the allocation flag is ‘0’. However, the embodiments are not limited thereto, and although the memory controller 231 may provide the refresh command to the memory chip, in which the allocation flag is ‘0’, the memory controller 231 may also skip the refresh operation inside the memory chip.

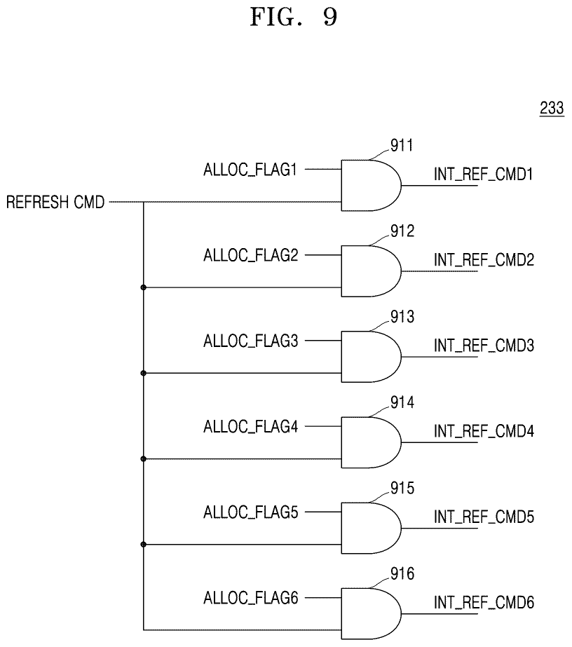

FIG. 9 is a circuit diagram for describing a structure of the refresh manager 233, according to one or more embodiments. FIG. 9 is described with reference to FIG. 5.

Referring to FIG. 9, the refresh manager 233 may receive the refresh command, and generate first through sixth internal refresh commands INT_REF_CMD1 through INT_REF_CMD6. The first through sixth internal refresh commands INT_REF_CMD1 through INT_REF_CMD6 may be provided to the first through sixth memory chips M_CHIP1 through M_CHIP6, respectively.

The refresh manager 233 may include first through sixth AND gates 911 through 916. The first through sixth AND gates 911 through 916 may commonly receive the refresh command, and respectively receive first through sixth allocation flags ALLOC_FLAG1 through ALLOC_FLAG6. The first through sixth AND gates 911 through 916 may output first through sixth internal refresh commands INT_REF_CMD1 through INT_REF_CMD6, respectively. Each of the first through sixth AND gates 911 through 916 may perform an AND operation on the allocation flag corresponding to the refresh command, and output a corresponding internal refresh command. In the in the embodiments of the present disclosure, the AND gate may be referred to as a selection circuit.

For example, as illustrated in FIG. 5, when the first memory chip M_CHIP1 is allocated to the host1 210_1, a first allocation flag may be ‘1’, and a first internal refresh command INT_REF_CMD1 may be the same as a refresh command. On the other hand, because no host has been allocated to the third memory chip M_CHIP3, a third allocation flag ALLOC_FAG3 may be ‘0’, and the third internal refresh command INT_REF_CMD3 may be maintained at logic low.

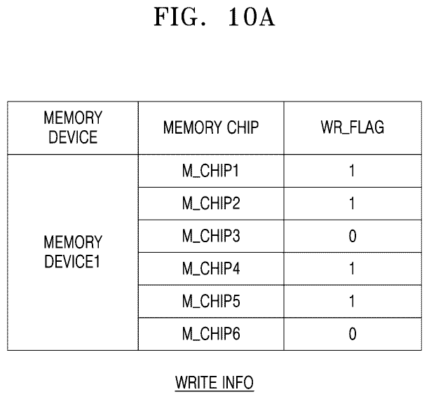

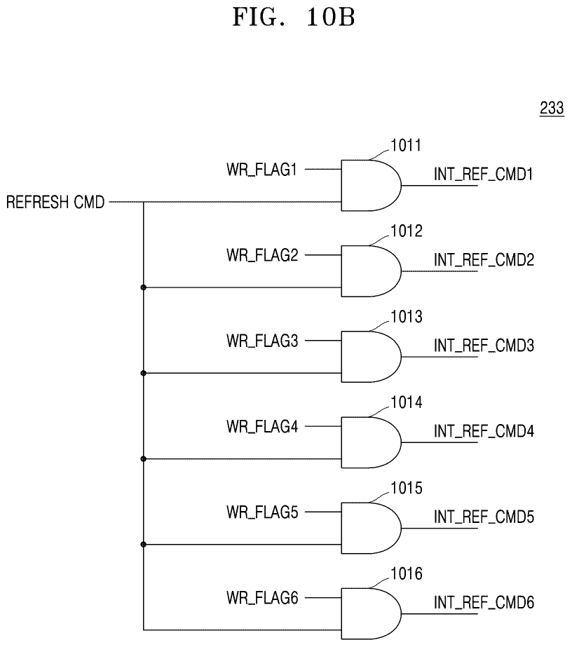

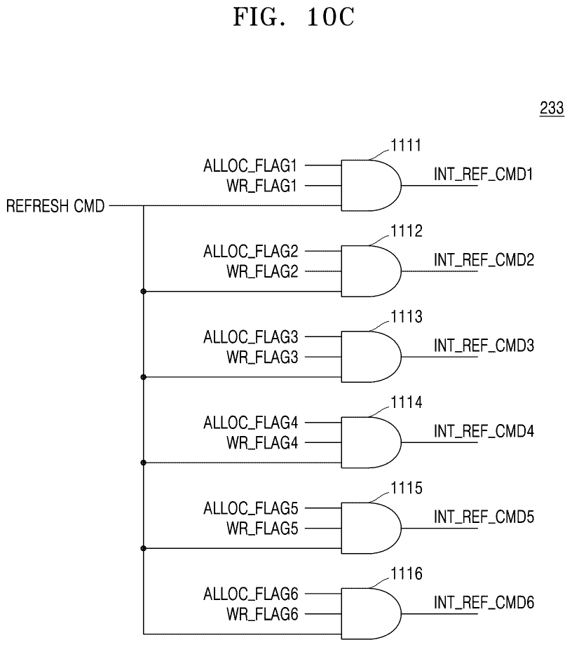

FIGS. 10A, 10B, and 10C are diagrams for describing a method of skipping the refresh operation by using a write flag, according to embodiments. FIG. 10A is described with reference to FIG. 5.

Referring to FIG. 10A, the refresh manager 233 may store write information. The write information may represent whether the write operation has been performed on the first through sixth memory chips M_CHIP1 through M_CHIP6.

When a write operation has been performed on a memory chip, a write flag WR_FLAG corresponding to the corresponding memory chip may be ‘1’, and when a write operation has not been performed on a memory chip, the write flag WR_FLAG corresponding to the corresponding memory chip may be ‘0’.

Referring to FIG. 10B, the refresh manager 233 may generate the first through sixth internal refresh commands INT_REF_CMD1 through INT_REF_CMD6 based on first through sixth write flags WR_FLAG1 through WR_FLAG6. The first through sixth write flags WR_FLAG1 through WR_FLAG6 may respectively correspond to the first through sixth memory chips M_CHIP1 through M_CHIP6. The first through sixth internal refresh commands INT_REF_CMD1 through INT_REF_CMD6 may be respectively provided to the first through sixth memory chips M_CHIP1 through M_CHIP6.

The refresh manager 233 may include first through sixth AND gates 1011 through 1016. The first through sixth AND gates 1011 through 1016 may commonly receive the refresh command, and respectively receive the first through sixth write flags WR_FLAG1 through WR_FLAG6. The first through sixth AND gates 1011 through 1016 may output first through sixth internal refresh commands INT_REF_CMD1 through INT_REF_CMD6, respectively. Each of the first through sixth AND gates 1011 through 1016 may perform an AND operation on the write flag corresponding to the refresh command, and output a corresponding internal refresh command.

For example, as illustrated in FIG. 10A, when the first, second, fourth, and fifth memory chips M_CHIP1, M_CHIP2, M_CHIP4, and M_CHIP5 are in a state of having a write operation performed, the first, second, fourth, and fifth write flags WR_FLAG1, WR_FLAG2, WR_FLAG4, and WR_FLAG5 may be ‘1’, and the first, second, fourth, and fifth internal refresh commands INT_REF_CMD1, INT_REF_CMD2, INT_REF_CMD4, and INT_REF_CMD5 may be the same as the refresh command. On the other hand, when the third and sixth memory chips M_CHIP3 and M_CHIP6 are in a state of having a write operation not performed, the third and sixth write flags WR_FLAG3 and WR_FLAG6 may be ‘0’, and the third and sixth internal refresh commands INT_REF_CMD3 and INT_REF_CMD6 may be maintained as logic low.

When allocation to the first memory device or the first through sixth memory chips M_CHIP1 through M_CHIP6 is released, the refresh manager 233 may skip the refresh operation on an allocation-released memory chip by resetting the write flag to ‘0’.

Referring to FIG. 10C, the refresh manager 233 may generate the first through sixth internal refresh commands INT_REF_CMD1 through INT_REF_CMD6 based on the first through sixth allocation flags ALLOC_FLAG1 through ALLOC_FLAG6 and the first through sixth write flags WR_FLAG1 through WR_FLAG6, respectively.

The refresh manager 233 may include first through sixth AND gates 1111 through 1116. The first through sixth AND gates 1111 through 1116 may command receive the refresh command. Each of the first through sixth AND gates 1111 through 1116 may perform an AND operation on the refresh command, the write flag corresponding to the refresh command, and the write flag corresponding to the refresh command, and output the internal refresh command corresponding to the result of the AND operation.

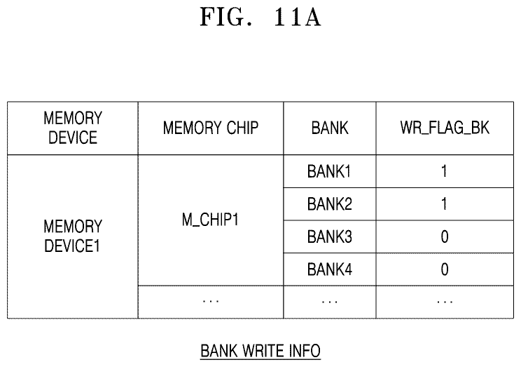

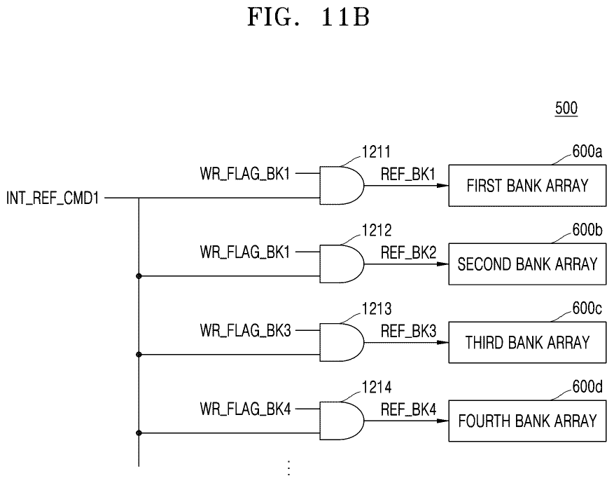

FIGS. 11A and 11B are diagrams for describing a write flag per bank WR_FLAG_BK according to embodiments. FIGS. 11A and 11B are described with reference to FIG. 7.

Referring to FIGS. 7 and 11A, the control logic circuit 510 may store bank write information BANK WRITE INFO. The bank write information BANK WRITE INFO may include a bank write flag WR_FLAG_BK indicating whether the write operation has been performed on first through fourth bank arrays 600a through 600d. For example, when the write operation has been performed on the first and second bank arrays 600a and 600b, the first and second bank write flags WR_FLAG_BK1 and WR_FLAG_BK2 are ‘1’, and when the write operation has not been performed on the third and fourth bank arrays 600c and 600d, the third and fourth bank write flags WR_FLAG_BK3 and WR_FLAG_BK4 may be ‘0’.

In FIG. 11A, only bank write information about the first memory chip M_CHIP1 included in the first memory device memory device1 (230_1 in FIG. 5) is illustrated, but one or more embodiments is not limited thereto. Arbitrary memory chips included in the memory device2 through memory devicek 230_2 through 230_k may store the bank write information.

Referring to FIG. 11B, the memory chip 500 may receive the first internal refresh command INT_REF_CMD1, and based on first through fourth bank refresh control signals REF_BK1 through REF_BK4, the memory chip 500 may control the refresh operation on the first through fourth bank arrays 600a through 600d.

The memory chip 500 may include first through fourth AND gates 1211 through 1214. The first through fourth AND gates 1211 through 1214 may commonly receive the first internal refresh command INT_REF_CMD1, and may respectively receive first through fourth bank write flags WR_FLAG_BK1 through WR_FLAG_BK4. The first through fourth AND gates 1211 through 1214 may respectively generate the first through fourth bank refresh control signals REF_BK1 through REF_BK4. Each of the first through fourth AND gates 1211 through 1214 may generate corresponding bank refresh control signals by performing the first internal refresh command INT_REF_CMD1 and the AND operation on the bank write flag corresponding to the first internal refresh command INT_REF_CMD1. In some embodiments, the first through fourth AND gates 1211 through 1214 may be included in the bank control logic circuit 530. The bank control logic circuit 530 may control the row decoder 560 and the column decoder 570 so that the bank array corresponding to the result of the AND operation of ‘1’ is activated.

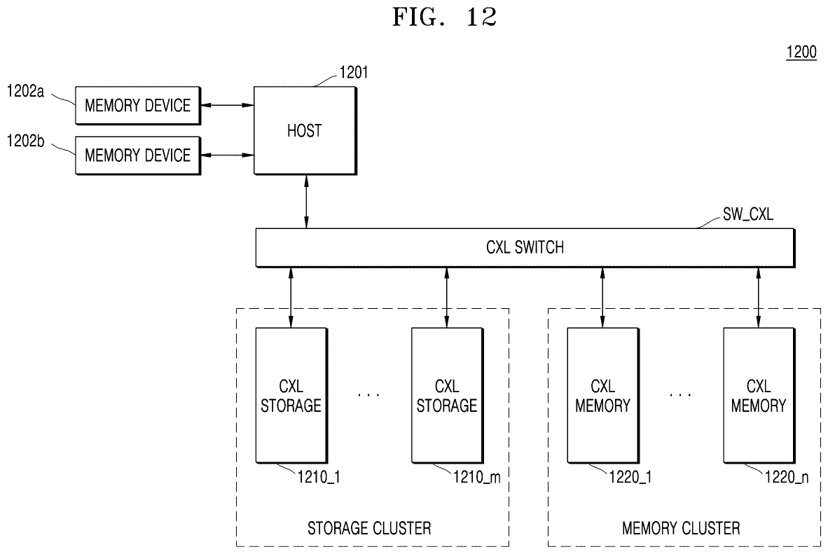

FIG. 12 is a block diagram of a computing system 1200 according to one or more embodiments. Hereinafter, for convenience of description, detailed descriptions of duplicate components are omitted.

Referring to FIG. 12, the computing system 1200 may include a host 1201, a plurality of memory devices 1202a and 1202b, the CXL switch SW_CXL, a plurality of CXL storages 1210_1 through 1210_m, and a plurality of CXL memories 1220_1 through 1220_n.

The host 1201 may be directly connected to the plurality of memory devices 1202a and 1202b. The host 1201, the plurality of CXL storages 1210_1 through 1210_m, and the plurality of CXL memories 1220_1 through 1220_n may be connected to the CXL switch SW_CXL, and each of them may communicate with each other via the CXL switch SW_CXL.

In one or more embodiments, the host 1201 may manage the plurality of CXL storages 1210_1 through 1210_m as one storage cluster, and may manage the plurality of CXL memories 1220_1 through 1220_n as one memory cluster. The host 1201 may allocate some area of the memory cluster to a dedicated area (e.g., an area for storing the map data of the storage cluster), with respect to the one storage cluster. In one or more examples, the host 1201 may allocate each area of the plurality of CXL memories 1220_1 through 1220_n as a dedicated area, with respect to the plurality of CXL storages 1210_1 through 1210_m.

FIG. 13 is a block diagram of a computing system 1300 according to one or more embodiments. Hereinafter, for convenience of description, detailed descriptions of duplicate components are omitted.

Referring to FIG. 13, the computing system 1300 may include a host 1301, a plurality of memory devices 1302a and 1302b, the CXL switch SW_CXL, a plurality of CXL storages 1310_1, 1310_2, and 1310_3, and a plurality of CXL memories 1320_1, 1320_2, and 1320_3.

The host 1301 may be directly connected to the plurality of memory devices 1302a and 1302b. The host 1301, the plurality of CXL storages 1310_1 and 1310_2 and the plurality of CXL memories 1320_1 and 1320_2 may be connected to the CXL switch SW_CXL, and each of them may communicate with each other via the CXL switch SW_CXL. Similarly to the descriptions given above, some area of the plurality of CXL memories 1320_1 and 1320_2 may be allocated as a dedicated area for the plurality of CXL storages 1310_1 and 1310_2.

In one or more embodiments, while the computing system 1300 is operating, some areas of the plurality of CXL storages 1310_1 and 1310_2 or some areas of the plurality of CXL memories 1320_1 and 1320_2 may be connect-removed or hot-removed from the CXL switch SW_CXL. In one or more examples, while the computing system 1300 is operating, a portion of the CXL storage 1310_3 or a portion of the CXL memory 1320_3 may be connected or hot-added to the CXL switch SW_CXL. In this case, the host 1301 may perform again the memory allocation by performing again an initialization operation on devices connected to the CXL switch SW_CXL by using a reset operation or a hot-plug operation. In one or more examples, a CXL storage and a CXL memory according to one or more embodiments of the embodiments of the present disclosure may support the hot-plug function, and expand a storage capacity and a memory capacity of a computing system by using various connections.

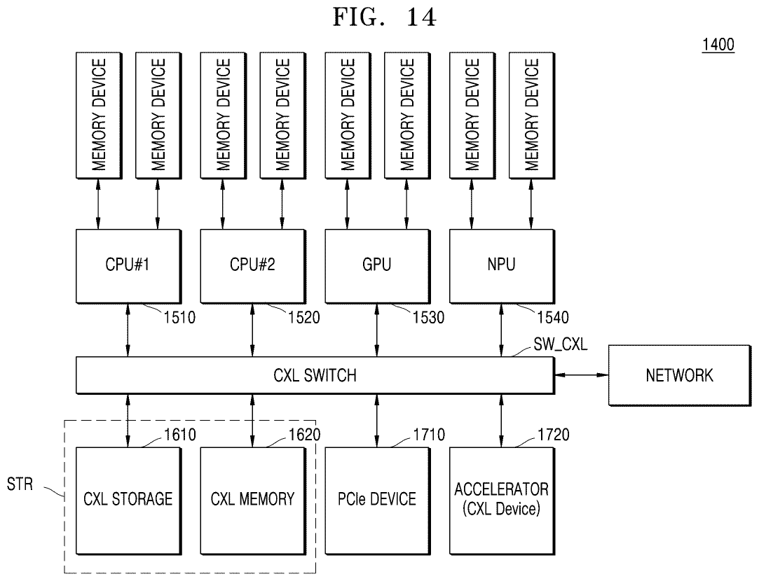

FIG. 14 is a block diagram of a computing system 1400 according to one or more embodiments. Hereinafter, for convenience of description, detailed descriptions of duplicate components are omitted.

Referring to FIG. 14, the computing system 1400 may include a first CPU CPU #1 1510, a second CPU CPU #2 1520, a GPU 1530, an NPU 1540, the CXL switch SW_CXL, a CXL storage 1610, a CXL memory 1620, a PCIe device 1710, and an accelerator (CXL device) 1720.

The first CPU CPU #1 1510, the CPU #2 1520, the GPU 1530, the NPU 1540, the CXL switch SW_CXL, the CXL storage 1610, the CXL memory 1620, the PCIe device 1710, and the accelerator (CXL device) 1720 may be commonly connected to the CXL switch SW_CXL, and each of them may communicate with each other via the CXL switch SW_CXL.

In one or more embodiments, each of the CPU #1 1510, the CPU #2 1520, the GPU 1530, and the NPU 1540 may include a host described with reference to FIGS. 1 through 8, and each of them may be directly connected to individual memory devices.

In one or more embodiments, the CXL memory 1620 may include a CXL memory described with reference to FIGS. 1 through 11B, and at least some area of the CXL memory 1620 may be allocated as a dedicated area for the CXL storage 1610 by using any one or more of the CPU #1 1510, the CPU #2 1520, the GPU 1530, and the NPU 1540. In one or more examples, the CXL storage 1610 and the CXL memory 1620 may be used as a storage space STR of the computing system 1400.

In one or more embodiments, the CXL switch SW_CXL may be connected to the PCIe device 1710 or the accelerator (CXL device) 1720 configured to support various functions, and the PCIe device 1710 or the accelerator (CXL device) 1720 may communicate with each of the CPU #1 1510, the CPU #2 1520, the GPU 1530, and the NPU 1540 via the CXL switch SW_CXL, or access the storage space STR including the CXL storage 1610 and the CXL memory 1620.

In one or more embodiments, the CXL switch SW_CXL may be connected to an external network or a Fabric, and may be configured to communicate with an external server via the external network or the Fabric.

While the embodiments of the present disclosure has been particularly shown and described with reference to embodiments thereof, it will be understood that various changes in form and details may be made therein without departing from the spirit and scope of the following claims.

What is claimed is:

1. A system comprising:
a plurality of memory devices, each of the plurality of memory devices comprising a plurality of memory areas;
a host configured to communicate with the plurality of memory devices; and
a switch circuit configured to store mapping information for a memory area allocated to the host from among the plurality of memory areas in the plurality of memory devices,
wherein a first memory device, from among the plurality of memory devices, is configured to receive at least a portion of the mapping information from the switch circuit, and perform a refresh operation on a plurality of first memory areas in the first memory device, based on at least the portion of the mapping information.

2. The system of claim 1, wherein the first memory device is further configured to:
perform the refresh operation on a first memory area allocated to the host from among the plurality of first memory areas, and
skip the refresh operation on a second memory area not allocated to the host from among the plurality of first memory areas.

3. The system of claim 1, wherein the first memory device comprises a memory controller configured to provide a refresh command to the plurality of first memory areas, based on an allocation flag indicating whether the plurality of first memory areas are allocated to the host.

4. The system of claim 3, wherein the memory controller comprises a plurality of first selection circuits, each of the plurality of first selection circuits corresponding to a respective memory area from the plurality of first memory areas,
wherein the plurality of first selection circuits commonly receive the refresh command, and
wherein each of the plurality of first selection circuits is configured to generate an internal refresh command based on the refresh command and the allocation flag indicating whether a corresponding first memory area from among the plurality of first memory areas is allocated to the host, and output the internal refresh command to the corresponding first memory area.

5. The system of claim 4, wherein each of the plurality of first selection circuits is further configured to generate the internal refresh command based on a write flag indicating whether a write operation has been performed in the corresponding first memory area, and output the internal refresh command to the corresponding first memory area.

6. The system of claim 5, wherein, based on an allocation between at least one first memory area from among the plurality of first memory areas and the host being released, the write flag for the allocation-released at least one first memory area is reset.

7. The system of claim 4, wherein the corresponding first memory area comprises:
a plurality of memory arrays, each of the plurality of memory arrays comprising a memory cell; and
a plurality of second selection circuits each configured to generate a control signal controlling the refresh operation on a corresponding memory array, based on the internal refresh command and a write flag indicating whether a write operation has been performed on the corresponding memory array.

8. The system of claim 7, wherein, based on an allocation between the corresponding first memory area and the host being released, the write flag for the plurality of memory arrays is reset.

9. An operating method of a system, the operating method comprising:
generating allocation information between a plurality of hosts and a plurality of memory devices;
providing, to a first memory device from among the plurality of memory devices, partial allocation information related to the first memory device from the allocation information, the first memory device comprising a plurality of memory areas;
performing, based on the partial allocation information, a refresh operation on a memory area allocated to at least one of the plurality of hosts from among the plurality of memory areas in the first memory device; and
skipping, based on the partial allocation information, the refresh operation on a memory area not allocated to the plurality of hosts from among the plurality of memory areas in the first memory device.

10. The operating method of claim 9, wherein the performing the refresh operation comprises providing a refresh command to at least one of the plurality of memory areas, based on an allocation flag indicating whether the plurality of memory areas has been allocated to at least one of the plurality of hosts.

11. The operating method of claim 10, wherein the providing the refresh command to the plurality of memory areas comprises:
generating an internal refresh command based on the refresh command and the allocation flag; and
providing the internal refresh command to a first memory area allocated to at least one of the plurality of hosts from among the plurality of memory areas.

12. The operating method of claim 11, wherein the generating the internal refresh command comprises generating the internal refresh command based on a write flag indicating whether a write operation has been performed on the plurality of memory areas.

13. The operating method of claim 12, further comprising, based on an allocation between at least one memory area of the plurality of memory areas and at least one host of the plurality of hosts being released, resetting the write flag for the allocation-released at least one memory area.

14. The operating method of claim 11, further comprising generating a control signal controlling a refresh operation on a plurality of memory arrays, based on the internal refresh command and a write flag indicating whether a write operation has been performed on the plurality of memory arrays in the first memory area.

15. The operating method of claim 14, further comprising, based on an allocation between the first memory area and the plurality of hosts being released, resetting the write flag for the plurality of memory arrays.

16. A system comprising:
a plurality of hosts;
a plurality of memory devices configured to communicate with the plurality of hosts, each of the plurality of memory devices comprising a plurality of memory areas; and
a switch circuit configured to store mapping information about a memory area allocated to at least one of the plurality of hosts from among the plurality of memory areas in the plurality of memory devices,
wherein a first memory device from among the plurality of memory devices is configured to receive at least a portion of the mapping information from the switch circuit, and perform a refresh operation on a plurality of first memory areas in the first memory device, based on at least the portion of the mapping information.

17. The system of claim 16, wherein the first memory device is further configured to:
perform the refresh operation on a first memory area allocated to at least one of the plurality of hosts from among the plurality of first memory areas, and
skip the refresh operation on a first memory area not allocated to the plurality of hosts from among the plurality of first memory areas.

18. The system of claim 16, wherein the first memory device comprises a memory controller configured to provide a refresh command to the plurality of first memory areas, based on an allocation flag indicating whether the plurality of first memory areas have been allocated to at least one of the plurality of hosts.

19. The system of claim 18, wherein the memory controller comprises a plurality of first selection circuits, each of the plurality of first selection circuits corresponding to a respective memory area from the plurality of first memory areas,
wherein the plurality of first selection circuits commonly receive the refresh command, and
wherein each of the plurality of first selection circuits is configured to generate an internal refresh command based on the refresh command and the allocation flag indicating whether a corresponding first memory area from among the plurality of first memory areas has been allocated to a host, and output the internal refresh command to the corresponding first memory area.

20. The system of claim 19, wherein each of the plurality of first selection circuits is further configured to the internal refresh command based on a write flag indicating whether a write operation has been performed in the corresponding first memory area, and output the internal refresh command to the corresponding first memory area.
